(19) United States
(12) Patent Application Publication
(10) Pub. No.: US 2017/0327220 A1
(43) Pub. Date: Nov. 16, 2017

(54) WATERPROOF UNMANNED AERIAL VEHICLE

(71) Applicant: Shenzhen SwellPro Technology Co., LTD, Shenzhen (CN)

(72) Inventor: Weiqiang Hu, Shenzhen (CN)

(21) Appl. No.: 15/264,600

(22) Filed: Sep. 14, 2016

(30) Foreign Application Priority Data
May 13, 2016 (CN) 201610317409.5
May 13, 2016 (CN) 201610321937.8
May 13, 2016 (CN) 201620435094.X
May 13, 2016 (CN) 201620438665.5
May 13, 2016 (CN) 201620441523.4
May 18, 2016 (CN) 201620453047.8
May 18, 2016 (CN) 201620459619.3

(51) Int. Cl. B64C 39/02; B64D 47/08; B64C 1/06; B64C 27/08

(52) U.S. Cl. CPC B64C 39/024; B64C 27/08; B64D 47/08; B64C 1/06; B64C 2201/108; B64C 2201/042

(57) ABSTRACT

A waterproof unmanned aerial vehicle includes an airframe, a first gasket, and a breathability member. The airframe includes an upper cover, a below cover assembled to the upper cover, and a receiving room. The upper cover includes a first protruding portion projecting from a bottom surface of the upper cover and a plurality of breathable holes in communication with the receiving room. The below cover defines a first receiving groove located in a top surface of the below cover. The first gasket is received in the first receiving groove, and the first protruding portion presses the first gasket to seal the upper cover and the below cover. The at least one breathability member includes a waterproof film covering the plurality of breathable holes to prevent water seep into the airframe and a fixing cover to fix the waterproof film on the upper cover.

### BACKGROUND

### 1. Technical Field

The present disclosure generally relates to unmanned aerial vehicles, and especially to a waterproof unmanned aerial vehicle.

### 2. Description of Related Art

With rapid development of the unmanned aerial vehicle (UAV) technology, the application range of the UAV is more and more wide. Traditionally, the UAV is limited to moisture-roof, but not waterproof, so that the traditional UAV cannot fly near a sea.

### SUMMARY

The disclosure relates to a waterproof unmanned aerial vehicle.

In one aspect, a waterproof unmanned aerial vehicle includes: an airframe, a first gasket, and at least one breathability member. The airframe includes an upper cover, a below cover assembled to the upper cover, and a receiving room surrounding by the upper cover and the below cover. The upper cover includes a first protruding portion projecting from a bottom surface of the upper cover and a plurality of breathable holes in communication with the receiving room. The below cover defines a first receiving groove located in a top surface of the below cover. The first gasket is received in the first receiving groove, and the first protruding portion presses the first gasket to seal the upper cover and the below cover. The at least one breathability member includes a waterproof film covering the plurality of breathable holes to prevent water seep into the airframe and a fixing cover to fix the waterproof film on the upper cover.

Wherein the upper cover comprises a first body, a battery cover fixed to the first body, and a second gasket, wherein the first body defines a first opening and a second receiving groove locating an inner wall of the first opening and for receiving the second gasket, and wherein the battery cover covers the first opening and comprises a second protruding portion, the second protruding portion presses the second gasket to seal the battery cover and the first body.

Wherein the waterproof unmanned aerial vehicle comprises a pair of locking members, the battery cover defines a pair of accommodating rooms, wherein each of the pair of locking members is received in each of the pair of accommodating rooms to lock the battery cover and the first body.

Wherein each of the pair of locking members comprises a locking post, a locking handle, and a locking stop, and each of the pair of accommodating rooms defines a locking hole, wherein each of the locking posts extends through each of the locking holes, the locking handle is assembled to an end of the locking post, and the locking stop is assembled to another end of the locking post.

Wherein the battery cover comprises a plurality of locating blocks, the upper cover comprises a plurality of locating holes defined in the inner wall of the first opening, wherein the plurality of locating blocks are received in the plurality of locating holes.

Wherein the upper cover comprises a pair of first connecting arms locating two opposite sides of the first body and a pair of first fixing arms connected to the pair of first connecting arms, the below cover comprises a second body, a pair of second connecting arms locating two opposite sides of the second body and a pair of second fixing arms connected to the pair of second connecting arms.

Wherein the waterproof unmanned aerial vehicle comprises a plurality of propellers assembled to the first fixing arms.

Wherein each of the plurality of propellers comprises a covering plate, a vane, a fastening member, and a motor, wherein the covering plate, the vane, and the fastening member are assembled via a plurality of fasteners, and the motor is assembled to the fastening member.

Wherein the fastening member comprises a base, an elastic element, and a fastening portion, wherein the base and the fastening portion are movably connected, and the elastic element is received in the base to prevent the fastening portion from accidently disengaging from the base.

Wherein the base comprises a plurality of first latching elements, the fastening portion comprises a plurality of second latching elements together with the first latching elements to latch the base and the fastening portion.

Wherein the fastening portion defines a plurality of passageways adjacent to the second latching elements, and each of the plurality of second latching elements comprises a receiving slot and a stopping part locating between the receiving slot and the passageway to prevent each of the plurality of first latching element from accidentally disengaging from the receiving slot, wherein each of the plurality of first latching elements is received in the receiving slot via the passageway.

In another aspect, a waterproof unmanned aerial vehicle includes an airframe comprising an upper cover and a below cover, and a cradle member assembled to the below cover. The cradle member includes a bracket fixed to the below cover, a first fixing frame fixed to the bracket, and a first rotating structure assembled to the first fixing frame. The first rotating structure includes a first rotating portion and a first motor mounted in the first rotating portion, wherein the first rotating portion comprises a first supporting part and a first rotating part rotating relative to the first supporting part, and wherein the first rotating part comprises a rotating post received in the first supporting part, the first supporting part comprises a positioning element to prevent the first rotating part from excessive rotation.

Wherein the cradle member a second fixing frame, a second rotating structure, a third fixing frame, a third rotating structure, and a waterproof camera. A first end of the second fixing frame is connected to the first rotating portion. The second rotating structure is assembled to a second end of the second fixing frame, and includes a second rotating portion and a second motor mounted in the second rotating portion. A first end of the third fixing frame is connected to the second rotating portion. The third rotating structure is connected a second end of third fixing frame, and includes a third rotating portion and a third motor mounted in the third rotating portion. The waterproof camera is assembled to the third rotating portion, wherein the waterproof camera includes a camera body, a camera cover, and a third gasket, the camera body defines a third receiving groove for receiving the third gasket, the camera cover comprises a third protruding portion to press the third gasket into the third receiving groove.

Wherein the first fixing frame comprises a first fixing plate, a second fixing plate, and a receiving space between the first fixing plate and the second fixing plate, and the first rotating structure comprises a first controlling box received in the receiving space to control the first motor.

Wherein the second rotating portion comprises a second supporting part and a second rotating part rotating relative to the second supporting part, the second rotating part comprises a rotating post received in the second supporting part, and the second supporting part comprises a positioning element to prevent the second rotating part from excessive rotation; and wherein the third rotating portion comprises a third supporting part and a third rotating part rotating relative to the third supporting part, the third rotating part comprises a rotating post received in the third supporting part, and the third supporting part comprises a positioning element to prevent the third rotating part from excessive rotation.

Wherein the second rotating structure comprises a second controlling box to control the second motor, the third rotating structure comprises a third controlling box to control the third motor, the first controlling box, the second controlling box, and the third controlling box are electrically connected.

Wherein bracket comprises a first bracket fixed to the below cover, a second bracket movably assembled to the first bracket, and the first fixing frame fixed to second bracket.

In another aspect, a waterproof unmanned aerial vehicle includes an airframe comprising an upper cover and a below cover, and at least one propeller assembled to upper cover. The least one propeller includes a covering plate, a vane, a fastening member, and a motor assembled to the fastening member. The fastening member, the covering plate, the vane, and the fastening member are assembled via a plurality of fasteners. The fastening member includes a base, an elastic element, and a fastening portion, wherein the base and the fastening portion are movably connected, and the elastic element is received in the base to prevent the fastening portion from disengaging accidently from the base, and wherein the base comprises a plurality of first latching elements, the fastening portion comprises a plurality of second latching elements and a plurality of passageways adjacent to the second latching elements, and each of the plurality of second latching elements comprises a receiving slot and a stopping part locating between the receiving slot and the passageway to prevent each of the plurality of first latching element from disengaging from the receiving slot, wherein each of the plurality of first latching elements is received in the receiving slot via the passageway.

Wherein the base comprises an accommodating cavity, the fastening portion comprises a fastening body received in the accommodating cavity, the second latching elements and the passageways are positioned on an outer circumference of the fastening body.

Wherein cross-sections of the upper cover and the below cover have generally H-shaped profile.

### BRIEF DESCRIPTION OF THE DRAWINGS

FIG. 1 is an assembled schematic view of a waterproof unmanned aerial vehicle of an exemplary of the present invention.

FIG. 2 is an exploded schematic view of an airframe and a first gasket of FIG. 1.

FIG. 3 is an inverted schematic view of an upper cover of FIG. 2;

FIG. 4 is an exploded schematic view of the upper cove and a pair of breathability members of FIG. 2;

FIG. 5 is enlarged schematic view of a battery cover of FIG. 4;

FIG. 6 is an exploded schematic view of a locking member of FIG. 5;

FIG. 7 is an exploded schematic view of a propeller of FIG. 1;

FIG. 8 is a part assembled schematic view of cradle member of FIG. 1;

FIG. 9 is a part exploded schematic view of cradle member of FIG. 1;

FIG. 10 is a schematic view of a first rotating structure of FIG. 9;

FIG. 11 is an exploded schematic view of a waterproof camera of FIG. 8; and

FIG. 12 is an inverted schematic view of a camera cover of FIG. 1.

### DETAILED DESCRIPTION

The disclosure is illustrated by way of example and not by way of limitation in the figures of the accompanying drawings, in which like reference numerals indicate similar elements. The embodiments described in accordance with the drawings are only examples, and thus the claimed invention is not limited thereto.

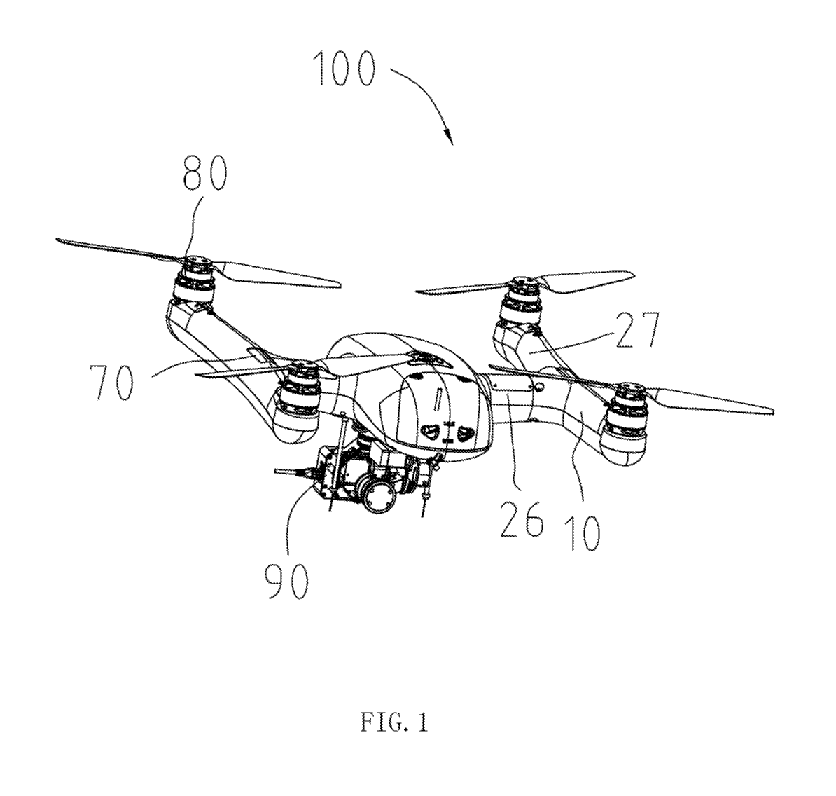

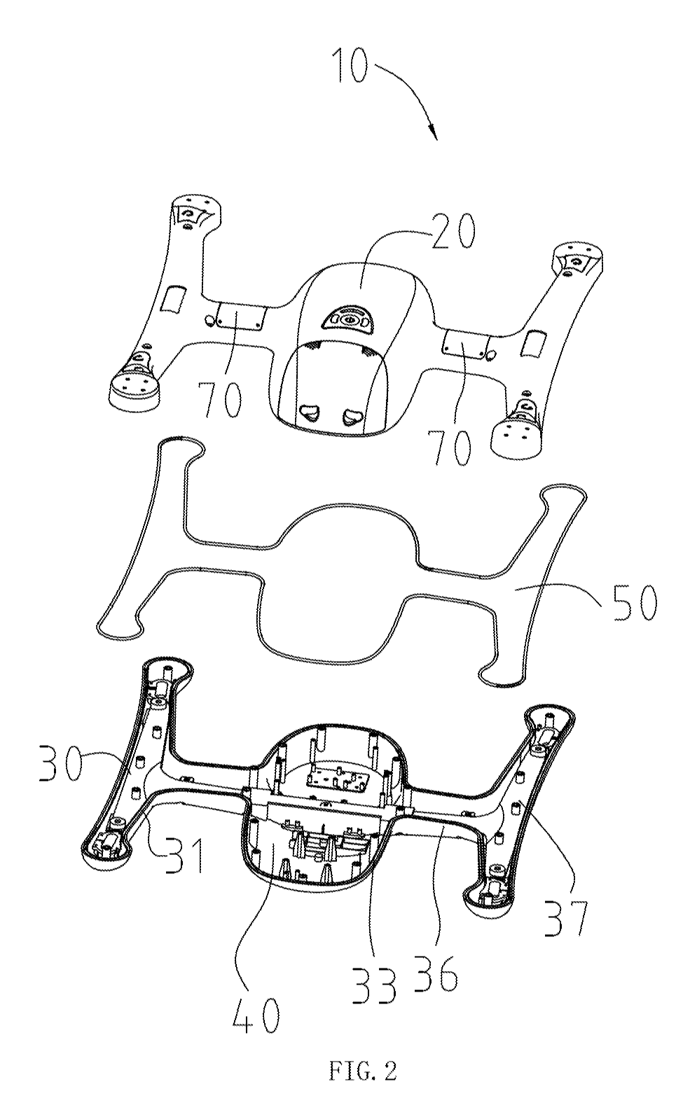

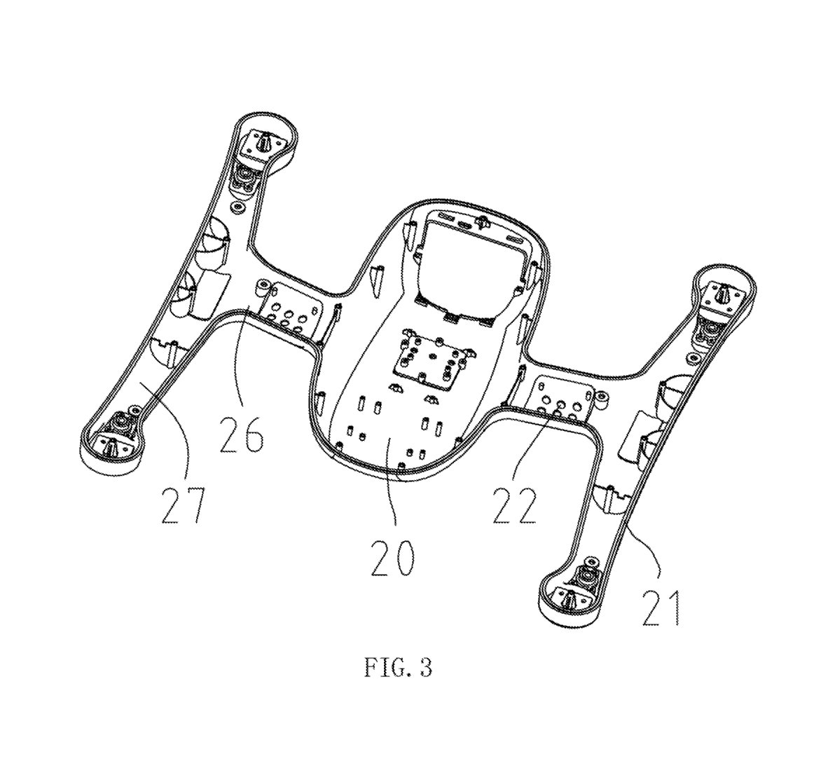

Referring to FIG. 1 to FIG. 4, the present invention provides a waterproof unmanned aerial vehicle 100. The waterproof unmanned aerial vehicle 100 includes an airframe 10, a first gasket 50, and at least one breathability member 70.

In one embodiment, the waterproof unmanned aerial vehicle 100 includes a pair of breathability members 70.

The airframe 10 includes an upper cover 20, a below cover 30, and a receiving room 40. The upper cover 20 includes a first protruding portion 21 projecting from a bottom surface of the upper cover 20 and a plurality of breathable holes 22. The below cover 30 is assembled to the upper cover 20. The below cover 30 defines a first receiving groove 31 located in a top of the below cover 30. The receiving room 40 is surrounded by the upper cover 20 and the below cover 30, and the first receiving groove 31 is in communication with the receiving room 40.

The first gasket 50 is received in the first receiving groove 31. The first protruding portion 21 presses tightly the first gasket 50 to seal the upper cover 20 and the below cover 30 to prevent water or moisture from seeping into the airframe 10.

In one embodiment, the first gasket 50 has a generally H-shaped profile.

Each of the pair of breathability members 70 includes a waterproof film 72 covering the breathable holes 22 to prevent water or moisture from seeping into the airframe 10 and a fixing cover 74 to fix the waterproof film 72 on the upper cover 20.

In one embodiment, the fixing cover 74 defines a plurality of small holes.

Because the first gasket 50 is received in the first receiving groove 31 of the below cover 30, and the first protruding portion 21 of the upper cover 20 presses tightly the first gasket 50, the water or moisture cannot seep into the airframe 10 to protect electronic components assembled in the airframe 10.

In one embodiment, the waterproof film 72 is made of nanometer materials. The waterproof film 72 can prevent water or moisture from seeping into the airframe 10, but atmosphere can enter the airframe 10 via the waterproof film 72, so that electronic components assembled in the airframe 10 can communicate with the outside electronic components with atmosphere as a medium, resulting in good communication effect.

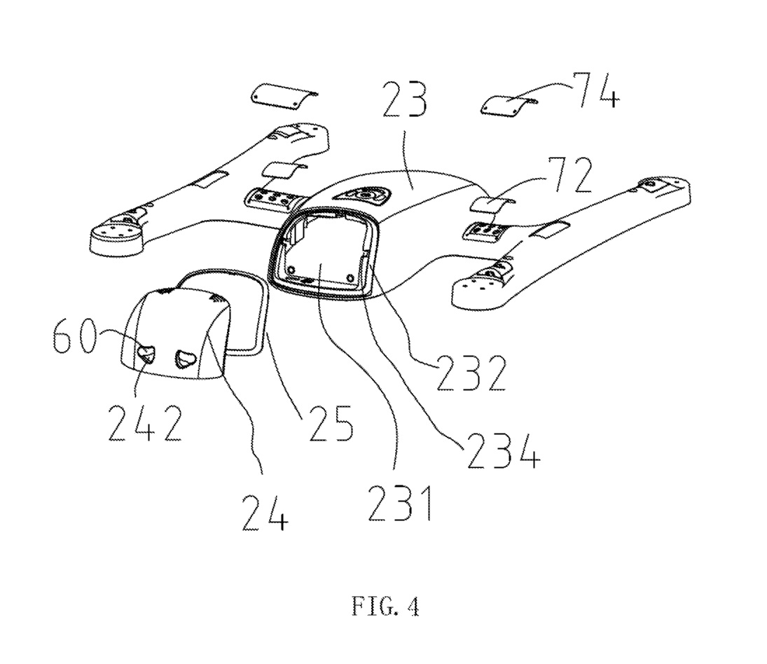

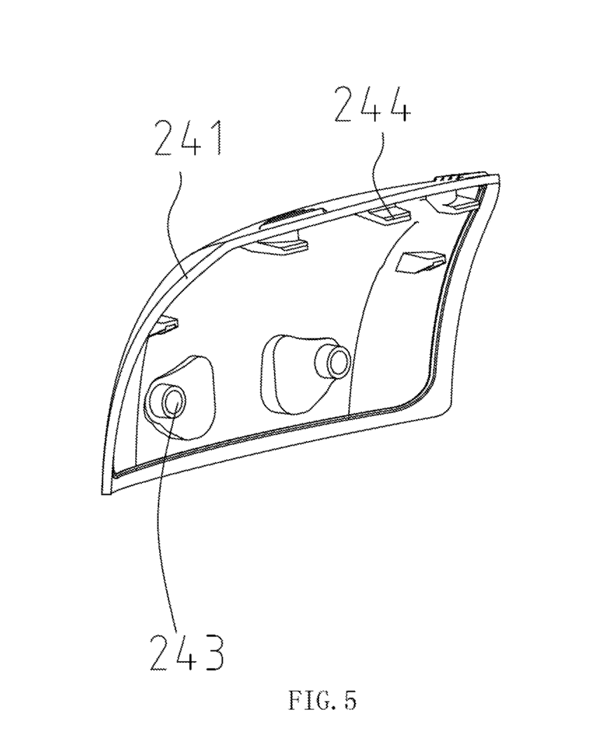

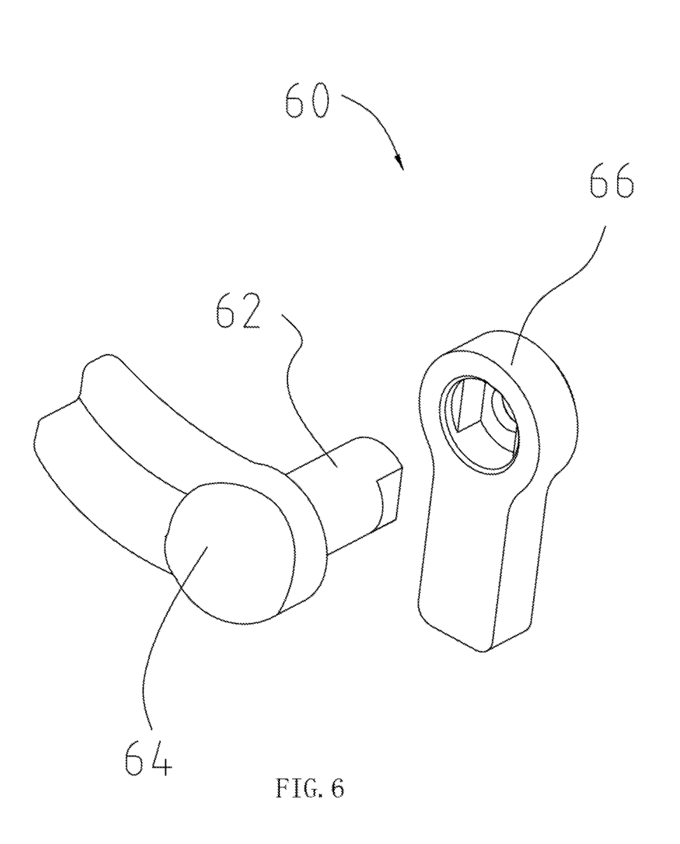

Referring to FIG. 4 to FIG. 6, the upper cover 20 includes a first body 23, a battery cover 24 mounted to the first body 23, and a second gasket 25. The first body 23 defines a first opening 231 and a second receiving groove 232 locating an inner wall of the first opening 231. The second gasket 25 is received in the second receiving groove 232. The battery cover 24 covers the first opening 231, and includes a second protruding portion 241. The second protruding portion 241 presses tightly the second gasket 25 to seal the battery cover 24 and the first body 23.

In one embodiment, the breathable holes 22 can be arranged in the first body 23 or the battery cover 24. The breathability members 70 can be mounted to the first body 23 or the battery cover 24.

The waterproof unmanned aerial vehicle 100 includes a pair of locking members 60. The battery cover 24 defines a pair of accommodating rooms 242. Each of the pair of locking members 60 is received in each of the pair of accommodating rooms 242 to lock the battery cover 24 and the first body 23. Each of the pair of locking members 60 comprises a locking post 62, a locking handle 64, and a locking stop 64, and each of the pair of accommodating rooms 242 defines a locking hole 243. Each of the locking posts 62 extends through each of the locking holes 243. The locking handle 64 is assembled to an end of the locking post 62, and the locking stop 66 is assembled to another end of the locking post 62.

Each of the pair of locking members 60 further comprises a gasket mounted to the locking post 62 to further seal the locking member 60 to prevent the water or moisture from seeping into the upper cover 20.

In use, when the battery cover 24 needs to be open, the locking handle 64 is rotated along a first direction to drive the locking member 60 move from a locking position to an unlocking position, so that the battery cover 24 can be disengaged from the upper cover 24. When the battery cover 24 needs to be closed, the locking handle 64 is rotated along a second direction opposite to the first direction to drive the locking member 60 move from the unlocking position to the locking position, so that the battery cover 24 can be latched to the first body 23.

Because the second gasket 25 is received in the second receiving groove 232 of the first body 23, and the second protruding portion 241 of the battery cover 25 presses the second gasket 25, the water or moisture cannot seep into the airframe 10 via an interface between the upper cover 20 and the battery cover 24 to protect the electronic components assembled in the airframe 10.

The battery cover 24 is locked to the first body 23 via the locking members 60 to prevent the battery cover 24 from accidentally disengaging from the first body 23, further the water or moisture cannot seep into the airframe 10 via the interface between the upper cover 20 and the battery cover 24.

The battery cover 24 includes a plurality of locating blocks. The first body 23 defines a plurality of locating groove 234 locating in the inner wall of the first opening 231. The plurality of locating blocks are received in the plurality of locating groove 234 to conveniently mount the battery cover 24 to the first body 23.

Referring to FIG. 1 to FIG. 3, the upper cover 20 includes a pair of first connecting arms 26 locating two opposite sides of the first body 23, and a pair of first fixing arms 27. The below cover 30 includes a second body 33, a pair of pair of second connecting arms 36 locating two opposite sides of the second body 33, and a pair of second fixing arms 37. Each of the pair of first fixing arms 27 is connected to each of the pair of first connecting arms 26. Each of pair of second fixing arms 37 is connected to each of the pair of second fixing arms 37.

In one embodiment, the first body 23, the pair of first fixing arms 27, and the pair of first connecting arms 26 are formed integrally. The second body 33, the pair of pair of second connecting arms 36, and pair of second fixing arms 37 are formed integrally.

In one embodiment, each of the pair of first connecting arms 26 defines the plurality of the breathable holes 22, and each of the breathability members 70 is mounted to the each of the pair of first connecting arms 26.

In one embodiment, cross-section of the upper cover 20 and the below cover 30 are generally H-shaped profile.

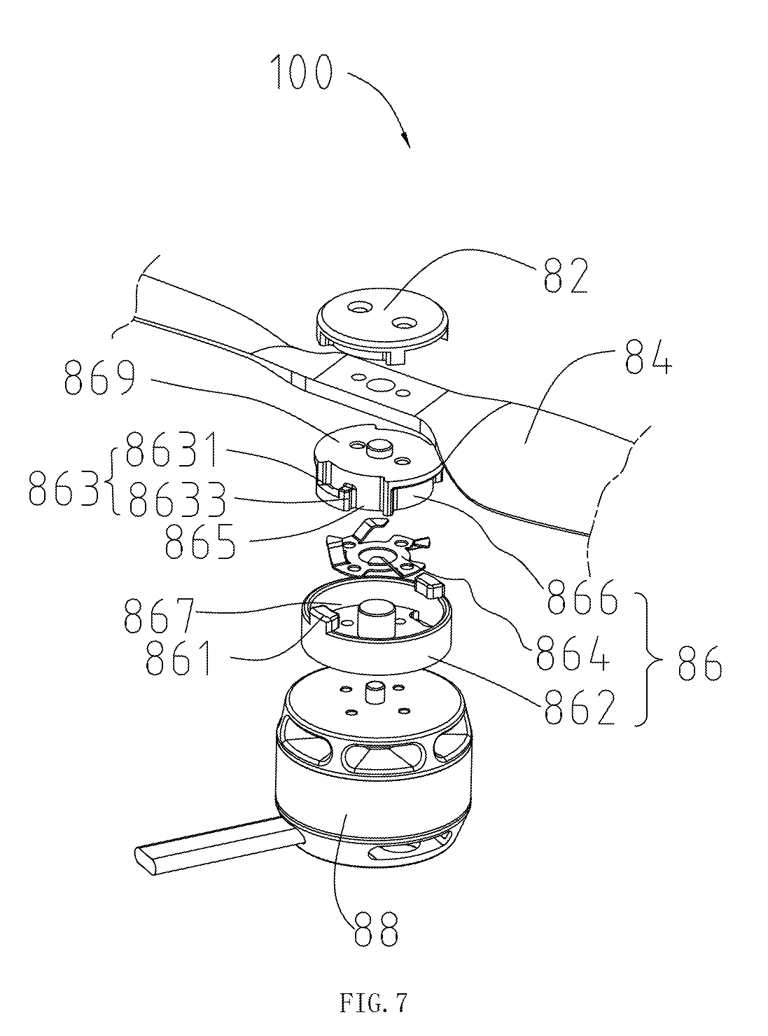

Referring to FIG. 1 and FIG. 7, the waterproof unmanned aerial vehicle 100 includes at least one propeller 80 assembled to the first fixing arms 27.

In another embodiment, the waterproof unmanned aerial vehicle 100 includes plurality of propellers 80.

Each of the plurality of propellers 80 includes a covering plate 82, a vane 84, a fastening member 86, and a motor 88. The covering plate 82, the vane 84, and the fastening member 86 are assembled to a whole via a plurality of fasteners, and the motor 88 is assembled to the fastening member 86. The fastening member 86 comprises a base 862, an elastic element 864, and a fastening portion 866. The base 862 and the fastening portion 866 are movably connected, and the elastic element 864 is received in the base 862 to prevent the fastening portion 866 from accidently disengaging from the base 862. In detail, the elastic element 864 is used to prevent the fastening portion 866 from accidently disengaging from the base 862 in an axial direction. That is to say, the base 862 and the fastening portion 866 are locked in the axial direction.

The base 862 includes a plurality of first latching elements 861. The fastening portion 866 includes a plurality of second latching elements 863 together with the first latching elements 861 to latch the base 862 and the fastening portion 866. The fastening portion 866 defines a plurality of passageways 865 adjacent to the second latching elements 863. Each of the plurality of second latching elements 863 includes a receiving slot 8631 and a stopping part 8633 locating between the receiving slot 8631 and the passageway 865 to prevent each of the plurality of first latching element 861 from accidently disengaging from the receiving slot 8631. Each of the plurality of first latching elements 861 is received in the receiving slot 8631 via the passageway 865.

The base 862 includes an accommodating cavity 867. The fastening portion 866 includes a fastening body 869 received in the accommodating cavity 867. The second latching elements 863 and the passageways 865 are positioned on an outer circumference of the fastening body 869. The second latching elements 863 is used to prevent each of the plurality of first latching element 861 from accidently disengaging from the receiving slot 8631 in a circumferential direction. That is to say, the base 862 and the fastening portion 866 are locked in the circumferential direction.

In assemble, the elastic element 864 is received a bottom of the accommodating cavity 867 of the in the base 862. Each of the plurality of first latching elements 861 is received in the receiving slot 8631 via the passageway 865 so that the base 862, the elastic element 864, and the fastening portion 866 are mounted to a whole. The covering plate 82, the vane 84, the fastening member 86, and the motor 88 are mounted to a whole via a plurality of fasteners, such as screws.

Because the base 862 and the fastening portion 866 are locked in the circumferential direction and the axial direction, during use the base 862 cannot accidentally disengage from the fastening portion 866, resulting in decreasing accidental damage of the waterproof unmanned aerial vehicle 100.

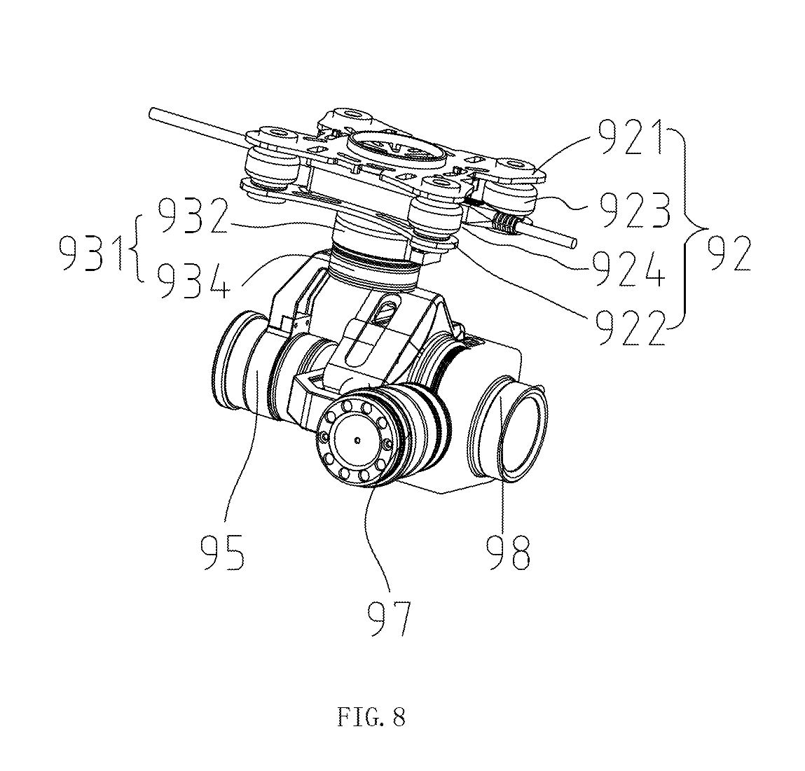

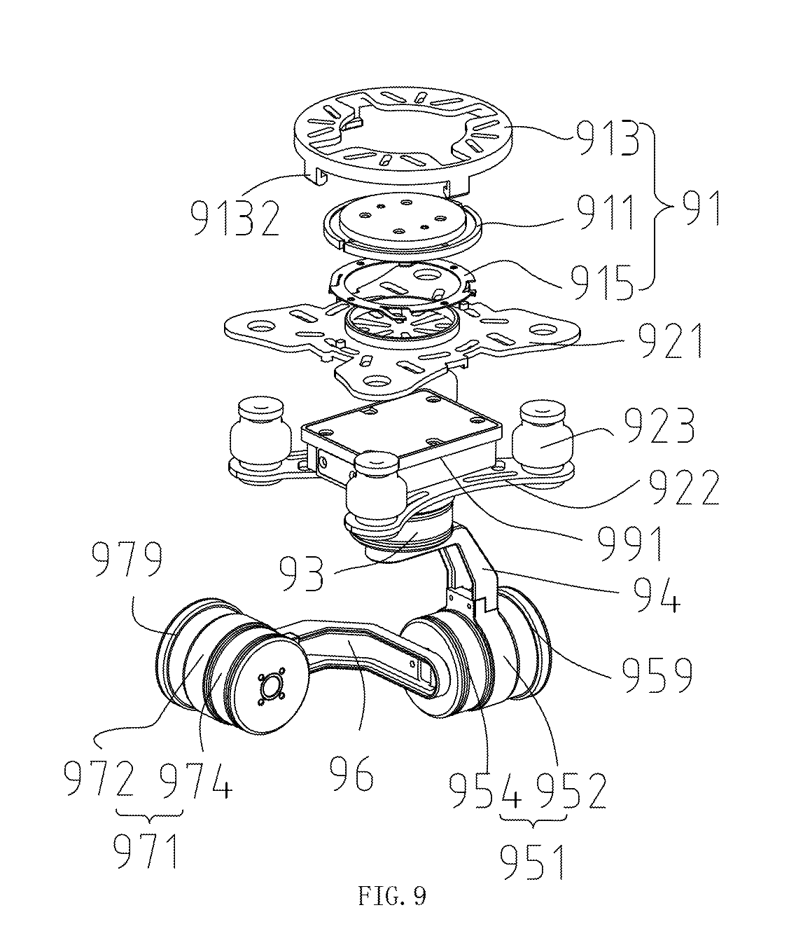

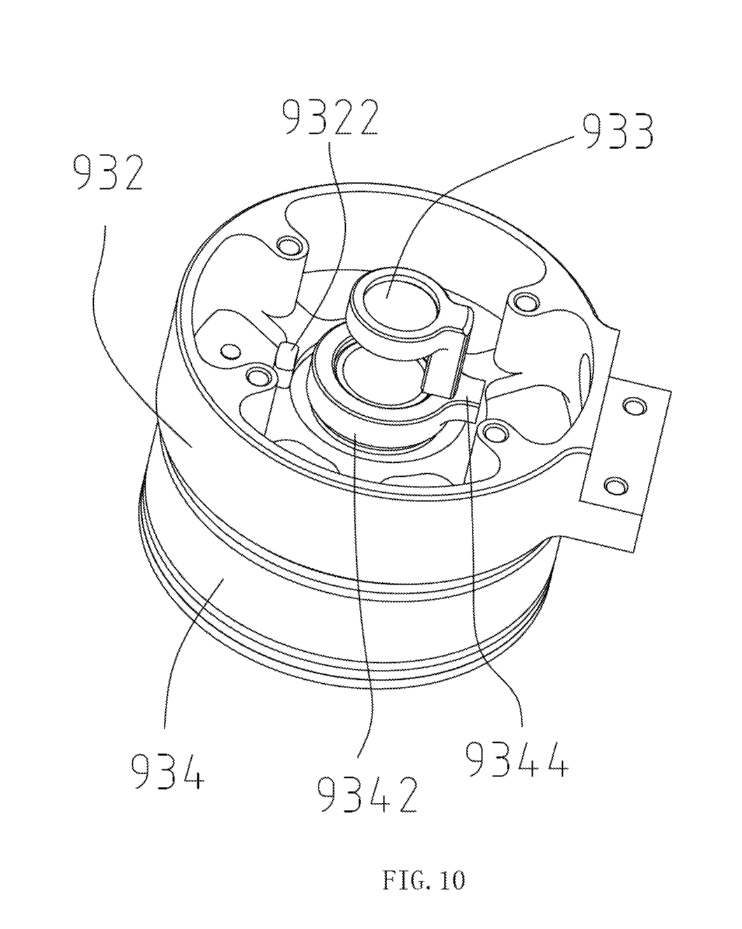

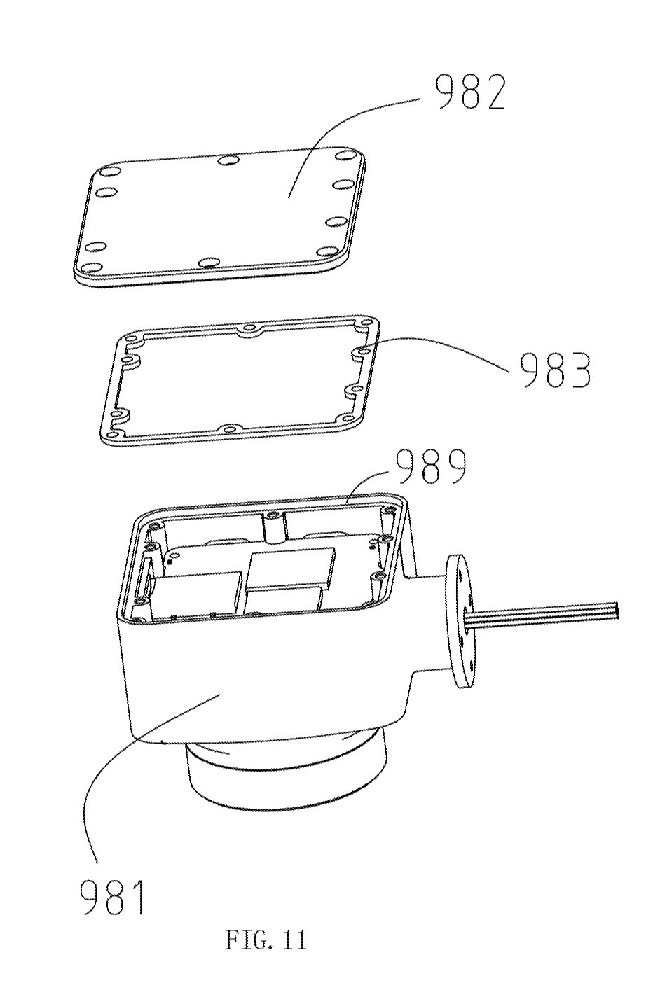

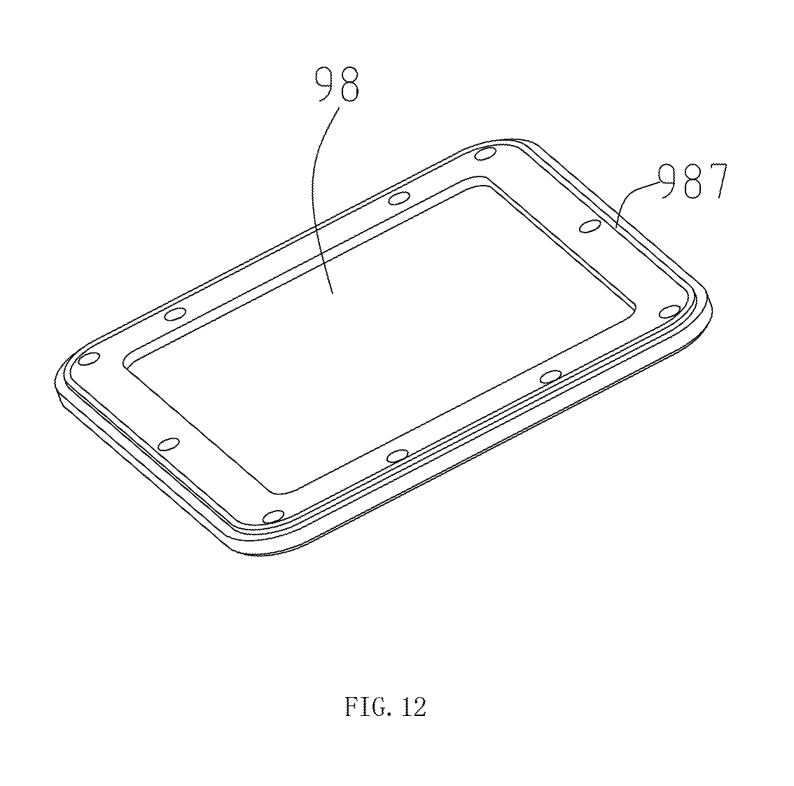

Referring to FIG. 1 and FIG. 8 to FIG. 12, the waterproof unmanned aerial vehicle 100 includes a cradle member 90 assembled to the below cover 30. The cradle member 90 includes a bracket 91 fixed to the below cover 30, a first fixing frame 92 fixed to the bracket 91, a first rotating structure 93 assembled to the first fixing frame 92, a second fixing frame 94, a second rotating structure 95, a third fixing frame 96, a third rotating structure 97, and a waterproof camera 98.

The bracket 91 includes a first bracket 911 fixed to the below cover 30, and a second bracket 913 movably assembled to the first bracket 911. The first fixing frame 92 is fixed to second bracket 913.

In one embodiment, the second bracket 913 can rotate relative to the first bracket 911.

The bracket 91 further includes an elastic plate 915. The elastic plate 915 is mounted to the first bracket 911 and located between the first bracket 911 and the first fixing frame 92, so that the second bracket 913 fastens tightly the first fixing frame 92.

In one embodiment, the elastic plate 915 is received in a groove defined in a bottom surface of the first bracket 911. The first bracket 913 is mounted to a bottom surface of the second bracket 913.

In one embodiment, the second bracket 913 includes a plurality of hooks 9132 to catch the first fixing frame 92 in order to prevent the first fixing frame 92 from accidentally disengaging from the bracket 91.

The first fixing frame 92 includes a first fixing plate 921, a second fixing plate 922, and a receiving space 924 between the first fixing plate 921 and the second fixing plate 922. The first rotating structure 93 includes a first controlling box 939 received in the receiving space 924.

In one embodiment, the bracket 92 includes a plurality of shock absorption portions 923 between the first plate 921 and the second plate 922 to decrease shock of the cradle member 90 during use. The shock absorption portions 923 are made of rubber.

The first rotating structure 93 is assembled to the first fixing frame 92. The first rotating structure 92 includes a first rotating portion 931 and a first motor 933 mounted in the first rotating portion 931. The first rotating portion 931 is fixed to the first controlling box 939. The first controlling box 939 controls the first motor 933. The first rotating portion 931 includes a first supporting part 932 and a first rotating part 934 rotating relative to the first supporting part 932. The first rotating part 934 includes a rotating post 9342 received in the first supporting part 932. The first supporting part 932 includes a positioning element 9322 to prevent the first rotating part 934 from excessive rotation.

In one embodiment, the positioning element 9322 is a first locating block. The rotating post 9342 includes a second locating block 9344 together with the first locating block to prevent the first rotating part 934 from excessive rotation.

In one embodiment, a rotation angle of the first rotating part 934 is 90 degrees to 350 degrees. The rotation angle of the first rotating part 934 is decided by widths of the first locating block and the second locating block 9344.

In another embodiment, the positioning element 9322 is a pair of first locating blocks separated by a certain distance. The rotation angle of the first rotating part 934 is 90 degrees to 270 degrees. The rotation angle of the first rotating part 934 is decided by the width of the second locating block 9344 and the distance between the pair of first locating blocks.

A first end of the second fixing frame 94 is connected to the first rotating portion 931. The second rotating structure 95 includes a second rotating portion 951 and a second motor mounted in the second rotating portion 951. The second rotating portion 951 is assembled to a second end of the second fixing frame 94. A first end of the third fixing frame 96 is connected to the second rotating portion 951. The third rotating structure 97 is connected a second end of third fixing frame 96. The third rotating structure 97 includes a third rotating portion 971 and a third motor mounted in the third rotating portion 971.

The waterproof camera 98 is assembled to the third rotating portion 971. The waterproof camera 98 includes a camera body 981, a camera cover 982, and a third gasket 983. The camera body 981 defines a third receiving groove 989 for receiving the third gasket 983. The camera cover 982 includes a third protruding portion 987 to press the third gasket 983 into the third receiving groove 989 to prevent water of moisture from seeping into the waterproof camera 98, so that the waterproof camera 98 can work when the waterproof camera 98 is in or near the sea.

The second rotating portion 951 comprises a second supporting part 952 and a second rotating part 954 rotating relative to the second supporting part 952. The second rotating part 954 comprises a rotating post (not labeled, equal to the rotating post 9342) received in the second supporting part 952, and the second supporting part 952 comprises a positioning element (not labeled, equal to the positioning element 9322) to prevent the second rotating part 954 from excessive rotation. The third rotating portion 971 comprises a third supporting part 972 and a third rotating part 974 rotating relative to the third supporting part 972. The third rotating part 974 comprises a rotating post (not labeled, equal to the rotating post 9342) received in the third supporting part 972, and the third supporting part 972 comprises a positioning element (not labeled, equal to the positioning element 9322) to prevent the third rotating part 974 from excessive rotation.

The second rotating structure 95 includes a second controlling box 959 to control the second motor. The third rotating structure 97 comprises a third controlling box 979 to control the third motor. The first controlling box 939, the second controlling box 959, and the third controlling box 979 are electrically connected. The second controlling box 959 is mounted to the second rotating portion 951. The third controlling box 979 is mounted to the third rotating portion 971. In addition, the first controlling box 939, the second controlling box 959, and the third controlling box 979 are waterproof box.

In assemble, the waterproof camera 98 is assembled to the third rotating structure 97. The third rotating structure 97 is mounted to the second end of third fixing frame 96. The first end of third fixing frame 96 is mounted to the second rotating structure 95. The second rotating structure 95 is mounted to the second end of the second fixing frame 94. The first end of the second fixing frame 94 is mounted to the first rotating structure 93. The first rotating structure 93 is assembled to the first fixing frame 92, and the first fixing frame 92 is mounted to the bracket 91. The bracket 91 is fixed to the below cover 30 via the first bracket 911 being fixed to the below cover 30. Thus, the cradle member 90 is mounted to the below cover 30.

In one embodiment, the structure and the function of the first rotating portion 931, the second rotating portion 951, and the third rotating portion 971 are the same. In addition, the first rotating portion 931 realizes a rotation of the waterproof camera 90 in a Y axis direction, the second rotating portion 951 realizes a rotation of the waterproof camera 90 in an X axis direction, and the third rotating portion 971 realizes a rotation of the waterproof camera 90 in a Z axis direction.

In one embodiment, the structure and the function of the firs motor 933, the second motor, and the third motor are the same.

In another embodiment, the structure and the function of the firs motor 933, the second motor, and the third motor may be different. The structure and the function of the first rotating portion 931, the second rotating portion 951, and the third rotating portion 971 may be different.

Referring to FIG. 1 to FIG. 11, in assemble, the first gasket 50 is received in the first receiving groove 31 of the below cover 30. The upper cover 20 is mounted to the below cover 30 with the first protruding portion 21 pressing the first gasket 50. The pair of locking members 60 are mounted to the battery cover 24, and the battery cover 24 is locked to the upper cover 20 via the pair of locking members 60. The cradle member 90 is mounted to the below cover 30 via the bracket 91. The plurality of propellers 80 are mounted to the upper cover 20. Thus, the upper cover 20, the below cover 30, the cradle member 90, and the plurality of propellers 80 are assembled into the waterproof unmanned aerial vehicle 100.

The first gasket 20 is mounted between the upper cover 20 and the below cover 30, and the second gasket 25 is mounted between the battery cover 24 and the first body 23 of the upper cover 20, so that the water or moisture cannot seep into the airframe 10 via the interface between the upper cover 20 and the below cover 30, and/or the battery cover 24 and the first body 23. In addition, the third gasket is mounted between the camera body 981 and the camera cover 983 so that the water or moisture cannot seep into the waterproof camera 98. Thus, the waterproof unmanned aerial vehicle 100 can fly near the sea, and the waterproof camera 98 can take pictures near or in the sea.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A waterproof unmanned aerial vehicle, comprising:
an airframe comprising:
an upper cover comprising a first protruding portion projecting from a bottom surface of the upper cover and a plurality of breathable holes;
a below cover assembled to the upper cover, the below cover defining a first receiving groove located in a top surface of the below cover; and
a receiving room surrounding by the upper cover and the below cover, the plurality of breathable holes in communication with the receiving room;
a first gasket received in the first receiving groove and the first protruding portion pressing the first gasket to seal the upper cover and the below cover; and
at least one breathability member, comprising a waterproof film covering the plurality of breathable holes to prevent water seep into the airframe and a fixing cover to fix the waterproof film on the upper cover.

2. The waterproof unmanned aerial vehicle as claimed in claim 1, wherein the upper cover comprises a first body, a battery cover fixed to the first body, and a second gasket, wherein the first body defines a first opening and a second receiving groove locating an inner wall of the first opening and for receiving the second gasket, and wherein the battery cover covers the first opening and comprises a second protruding portion, the second protruding portion presses the second gasket to seal the battery cover and the first body.

3. The waterproof unmanned aerial vehicle as claimed in claim 2, wherein the waterproof unmanned aerial vehicle comprises a pair of locking members, the battery cover defines a pair of accommodating rooms, wherein each of the pair of locking members is received in each of the pair of accommodating rooms to lock the battery cover and the first body.

4. The waterproof unmanned aerial vehicle as claimed in claim 3, wherein each of the pair of locking members comprises a locking post, a locking handle, and a locking stop, and each of the pair of accommodating rooms defines a locking hole, wherein each of the locking posts extends through each of the locking holes, the locking handle is assembled to an end of the locking post, and the locking stop is assembled to another end of the locking post.

5. The waterproof unmanned aerial vehicle as claimed in claim 4, wherein the battery cover comprises a plurality of locating blocks, the upper cover comprises a plurality of locating holes defined in the inner wall of the first opening, wherein the plurality of locating blocks are received in the plurality of locating holes.

6. The waterproof unmanned aerial vehicle as claimed in claim 2, wherein the upper cover comprises a pair of first connecting arms locating two opposite sides of the first body and a pair of first fixing arms connected to the pair of first connecting arms, the below cover comprises a second body, a pair of second connecting arms locating two opposite sides of the second body and a pair of second fixing arms connected to the pair of second connecting arms.

7. The waterproof unmanned aerial vehicle as claimed in claim 6, wherein the waterproof unmanned aerial vehicle comprises a plurality of propellers assembled to the first fixing arms.

8. The waterproof unmanned aerial vehicle as claimed in claim 7, wherein each of the plurality of propellers comprises a covering plate, a vane, a fastening member, and a motor, wherein the covering plate, the vane, and the fastening member are assembled via a plurality of fasteners, and the motor is assembled to the fastening member.

9. The waterproof unmanned aerial vehicle as claimed in claim 8, wherein the fastening member comprises a base, an elastic element, and a fastening portion, wherein the base and the fastening portion are movably connected, and the elastic element is received in the base to prevent the fastening portion from accidently disengaging from the base.

10. The waterproof unmanned aerial vehicle as claimed in claim 9, wherein the base comprises a plurality of first latching elements, the fastening portion comprises a plurality of second latching elements together with the first latching elements to latch the base and the fastening portion.

11. The waterproof unmanned aerial vehicle as claimed in claim 10, wherein the fastening portion defines a plurality of passageways adjacent to the second latching elements, and each of the plurality of second latching elements comprises a receiving slot and a stopping part locating between the receiving slot and the passageway to prevent each of the plurality of first latching element from accidentally disengaging from the receiving slot, wherein each of the plurality of first latching elements is received in the receiving slot via the passageway.

12. A waterproof unmanned aerial vehicle, comprising:
an airframe comprising an upper cover and a below cover; and
a cradle member assembled to the below cover, the cradle member comprising:
a bracket fixed to the below cover;
a first fixing frame fixed to the bracket; and
a first rotating structure assembled to the first fixing frame, the first rotating structure comprising a first rotating portion and a first motor mounted in the first rotating portion, wherein the first rotating portion comprises a first supporting part and a first rotating part rotating relative to the first supporting part, and wherein the first rotating part comprises a rotating post received in the first supporting part, the first supporting part comprises a positioning element to prevent the first rotating part from excessive rotation.

13. The waterproof unmanned aerial vehicle as claimed in claim 12, wherein the cradle member comprising:
a second fixing frame, a first end of the second fixing frame connected to the first rotating portion;
a second rotating structure assembled to a second end of the second fixing frame, the second rotating structure comprising a second rotating portion and a second motor mounted in the second rotating portion;
a third fixing frame, a first end of the third fixing frame connected to the second rotating portion;
a third rotating structure connected a second end of third fixing frame, the third rotating structure comprising a third rotating portion and a third motor mounted in the third rotating portion; and
a waterproof camera assembled to the third rotating portion, wherein the waterproof camera comprises a camera body, a camera cover, and a third gasket, the camera body defines a third receiving groove for receiving the third gasket, the camera cover comprises a third protruding portion to press the third gasket into the third receiving groove.

14. The waterproof unmanned aerial vehicle as claimed in claim 13, wherein the first fixing frame comprises a first fixing plate, a second fixing plate, and a receiving space between the first fixing plate and the second fixing plate, and the first rotating structure comprises a first controlling box received in the receiving space to control the first motor.

15. The waterproof unmanned aerial vehicle as claimed in claim 14, wherein the second rotating portion comprises a second supporting part and a second rotating part rotating relative to the second supporting part, the second rotating part comprises a rotating post received in the second supporting part, and the second supporting part comprises a positioning element to prevent the second rotating part from excessive rotation; and wherein the third rotating portion comprises a third supporting part and a third rotating part rotating relative to the third supporting part, the third rotating part comprises a rotating post received in the third supporting part, and the third supporting part comprises a positioning element to prevent the third rotating part from excessive rotation.

16. The waterproof unmanned aerial vehicle as claimed in claim 15, wherein the second rotating structure comprises a second controlling box to control the second motor, the third rotating structure comprises a third controlling box to control the third motor, the first controlling box, the second controlling box, and the third controlling box are electrically connected.

17. The waterproof unmanned aerial vehicle as claimed in claim 12, wherein bracket comprises a first bracket fixed to the below cover, a second bracket movably assembled to the first bracket, and the first fixing frame fixed to second bracket.

18. A waterproof unmanned aerial vehicle, comprising:
an airframe comprising an upper cover and a below cover; and
at least one propeller assembled to upper cover, the least one propeller comprising:
a covering plate;
a vane;
a fastening member, the covering plate, the vane, and the fastening member are assembled via a plurality of fasteners, the fastening member comprising a base, an elastic element, and a fastening portion, wherein the base and the fastening portion are movably connected, and the elastic element is received in the base to prevent the fastening portion from disengaging accidently from the base, and wherein the base comprises a plurality of first latching elements, the fastening portion comprises a plurality of second latching elements and a plurality of passageways adjacent to the second latching elements, and each of the plurality of second latching elements comprises a receiving slot and a stopping part locating between the receiving slot and the passageway to prevent each of the plurality of first latching element from disengaging from the receiving slot, wherein each of the plurality of first latching elements is received in the receiving slot via the passageway; and
a motor assembled to the fastening member.

19. The waterproof unmanned aerial vehicle as claimed in claim 18, wherein the base comprises an accommodating cavity, the fastening portion comprises a fastening body received in the accommodating cavity, the second latching elements and the passageways are positioned on an outer circumference of the fastening body.

20. The waterproof unmanned aerial vehicle as claimed in claim 18, wherein cross-sections of the upper cover and the below cover have generally H-shaped profile.
